(19) United States
(12) Patent Application Publication
(10) Pub. No.: US 2007/0129869 A1
(43) Pub. Date: Jun. 7, 2007

(54) System for autonomous cooperative control of multiple machines

(75) Inventors: Adam J. Gudat, Chillicothe, IL (US); Bryan D. Brown, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/294,357

(22) Filed: Dec. 6, 2005

(51) Int. Cl. G06F 19/00

(52) U.S. Cl. 701/50; 701/48

(57) ABSTRACT

A control system for a host work machine operating at a worksite with one or more other work machines is disclosed. The control system has a communication device operatively connected to the host work machine, and a controller. The controller has stored in a memory thereof one or more parameters associated with a predetermined task and is configured to autonomously control the host work machine to perform the predetermined task. Upon the host work machine encountering a need for assistance, the controller is further configured to communicate a request for assistance to at least one of the one or more other work machines via the communication device.

### TECHNICAL FIELD

The present disclosure relates generally to an autonomous work machine control system, and more particularly, to a system for controlling the autonomous cooperative operation of multiple work machines.

### BACKGROUND

Work machines such as, for example, excavators, loaders, dozers, motor graders, haul trucks, and other types of heavy machinery may be used to perform a variety of tasks. During the performance of these tasks, the work machines may operate in situations that are hazardous to an operator, under extreme environmental conditions uncomfortable for the operator, or at work locations remote from civilization. In addition, some of the tasks may require very precise and accurate control over operation of the work machine that may be difficult for an operator to provide. Because of these factors, the completion of some tasks by an operator-controlled work machine can be expensive, labor intensive, time consuming, and inefficient.

One method of improving the operation of a work machine under such conditions is described in U.S. Pat. No. 5,646,844 (the '844 patent) issued to Gudat et al. on Jul. 8, 1997. The '844 patent describes a control system that generates a common, dynamically updated, site database that shows the positions of all machines at a single worksite and site progress in real time. The common site database may be used to autonomously direct the operation of one machine with respect to another machine to avoid interference. In addition, the site update information can be used to autonomously control one or more machine components such as, for example, pumps, valves, hydraulic cylinders, motor/steering mechanisms, and other work machine devices to alter the geography at the worksite.

Although the control system of the '844 patent may help prevent collisions between work machines and may improve some operations of a single work machine through autonomous control, it may be limited. In particular, the control system of the '844 patent does not provide for cooperative completion of a task by multiple work machines. For example, a clearing task requiring a dozing operation followed by a ripping operation may not be completed by a single dozer having only a dozing blade or only a ripper, even if autonomously controlled as described in the '844 patent. For this reason, the control system of the '844 patent may be limited to accomplishing simple tasks that require the capabilities of a single work machine.

The disclosed control system is directed to overcoming one or more of the problems set forth above.

### SUMMARY OF THE INVENTION

In one aspect, the present disclosure is directed to a control system for a host work machine operating at a worksite with one or more other work machines. The control system includes a communication device operatively connected to the host work machine, and a controller having stored in a memory thereof one or more parameters associated with a predetermined task. The controller is configured to autonomously control the host work machine to perform the predetermined task. Upon encountering a need for assistance, the controller is further configured to communicate a request for assistance to at least one of the one or more other work machines at the worksite via the communication device.

In another aspect, the present disclosure is directed to another control system for a host work machine operating at a worksite. The control system includes a communication device operatively connected to the host work machine, and a controller having stored in a memory thereof a list of capabilities associated with the host work machine. The controller is configured to receive a request for assistance from another work machine at the worksite, and receive one or more parameters associated with the requested assistance. The controller is further configured to compare the one or more parameters to the list of capabilities and communicate to the other work machine an ability to assist the other work machine, if the comparison indicates that the host work machine is capable of assisting the other work machine.

In yet another aspect, the present disclosure is directed to a method of autonomously controlling a first work machine operating at a worksite. The method includes receiving one or more parameters associated with a predetermined task, and autonomously controlling the first work machine to perform the predetermined task. Upon encountering a need for assistance, the method further includes autonomously communicating a request for assistance to at least a second work machine at the worksite.

In yet another aspect, the present disclosure is directed to another method of autonomously controlling a host work machine operating at a worksite with at least one other work machine. The method includes autonomously receiving a request for assistance from the at least one other work machine at the worksite, and autonomously receiving one or more parameters associated with the request for assistance. The method further includes autonomously comparing the one or more parameters to a list of capabilities associated with the host work machine, and autonomously communicating to the at least one other work machine an ability to assist the at least one other work machine if the comparison indicates that the host work machine is capable of assisting the at least one other work machine.

### BRIEF DESCRIPTION OF THE DRAWINGS

FIG. 1 is a pictorial illustration of an exemplary worksite;

FIG. 2 is a pictorial illustration of an exemplary disclosed work machine associated with the worksite of FIG. 1;

FIG. 3A is a flow chart illustrating an exemplary disclosed method of operating the work machine of FIG. 2; and

FIG. 3B is a flow chart illustrating another exemplary disclosed method of operating the work machine of FIG. 2.

### DETAILED DESCRIPTION

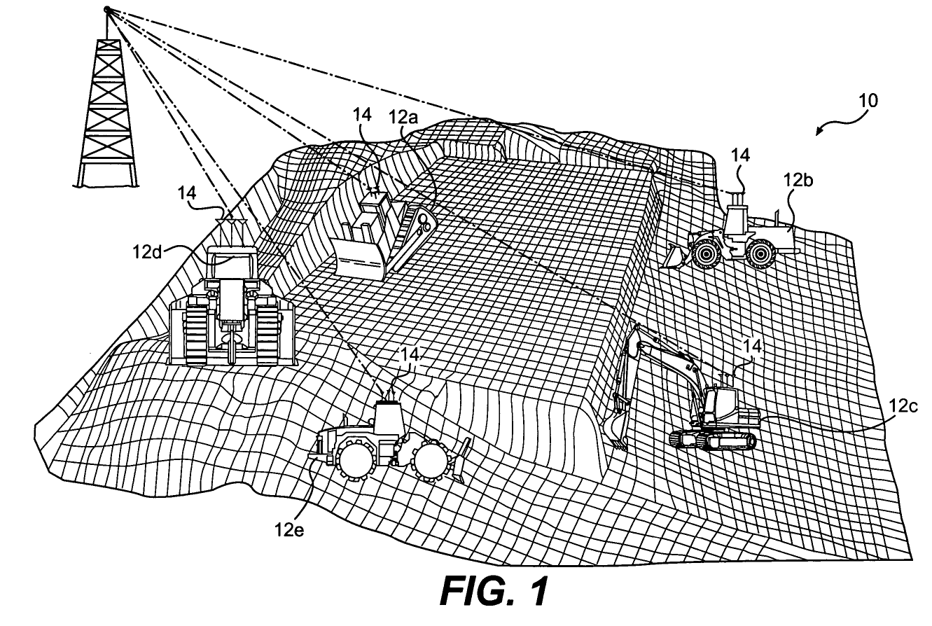

FIG. 1 illustrates an exemplary worksite 10 having multiple, simultaneously-operable work machines 12 performing a variety of predetermined tasks. Worksite 10 may include, for example, a mine site, a landfill, a quarry, a construction site, or any other type of worksite known in the art. The predetermined tasks may be associated with altering the current geography at worksite 10 to an architecturally desired geography. For example, the predetermined tasks may include a compacting operation, a clearing operation, a leveling operation, a hauling operation, a digging operation, a loading operation, or any other type of operation that functions to alter the current geography at worksite 10.

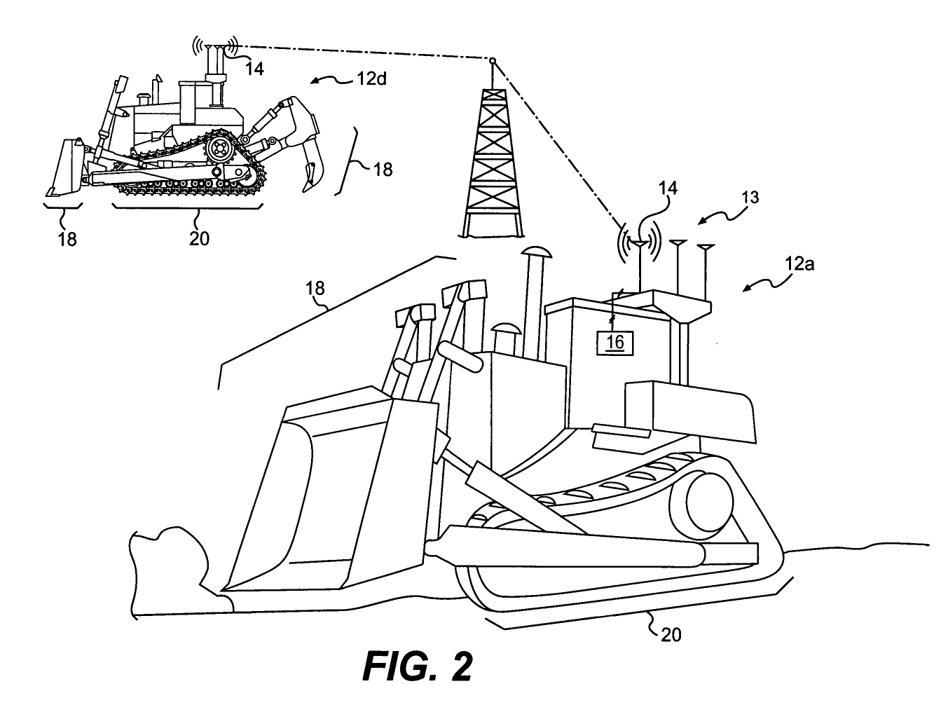

Work machines 12 may include systems and components that cooperate to accomplish the predetermined tasks. Each work machine 12 may embody a fixed or mobile machine that performs some type of operation associated with an industry such as mining, construction, farming, transportation, or any other industry known in the art. For example, work machine 12 may embody an earth moving machine such as a dozer 12a having a blade implement, a loader 12b, an excavator 12c, a dozer 12d having a ripping implement, a compactor 12e, a haul truck (not shown), a backhoe (not shown), or any other earth moving machine. Work machine 12 may alternatively embody a non-earth moving machine such as, for example, a passenger vehicle, a marine vessel, or any other suitable work machine known in the art. As best illustrated in FIG. 2, each work machine 12 may include a control system 13 having a communication device 14 configured to exchange data with one or more other work machines 12 at worksite 10, and a controller 16 operatively connected to communication device 14.

Communication device 14 may embody any mechanism that facilitates the exchange of data between work machines 12. For example, communication device 14 may include hardware and/or software that enables each work machine 12 to send and/or receive data messages through a direct data link (not shown) or a wireless communication link. The wireless communications may include, for example, satellite, cellular, infrared, and any other type of wireless communications that enable work machines 12 to wirelessly exchange information.

Controller 16 may include any means for monitoring, recording, storing, indexing, processing, and/or communicating the operational aspects of work machine 12. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

Controller 16 may be configured to autonomously control operations of work machine 12 to complete the predetermined tasks. In particular, controller 16 may be in communication with the actuation components (not shown) of a work machine implement system 18 and/or a work machine drive system 20. For example, controller 16 may communicate with one or more hydraulic pumps of work machine 12, with various hydraulic control valves, hydraulic cylinders, motor/steering mechanisms, power sources, transmission devices, traction devices, and other actuation components of work machine 12 to initiate, modify, or halt operations of implement and drive systems 18, 20. It is contemplated that controller 16 may use conventional work machine and work tool location/positioning systems and/or other such guidance systems to accurately control the operation of work machine 12. In this manner, controller 16 may provide for partial or full automatic control of work machine 12.

Controller 16 may receive one or more parameters associated with the current geography and the architecturally desired geography. For example, controller 16 of each work machine 12 may be provided with a common electronic representation of the current geography of worksite 10 and a corresponding common electronic representation of the desired geography. As controllers 16 operate work machines 12 to alter the current worksite 10 based on the differences between the current and desired geographies, the common electronic representations may be dynamically updated according to various sensing and positioning equipment mounted to or located within work machines 12. It is contemplated that each controller 16 may also be provided with or be configured to sense varying environmental parameters of worksite 10 including, among other things, soil composition, the location of ore bodies or boundaries, compaction levels, temperatures, humidity levels, vegetation characteristics, and soil hardness levels.

Each work machine 12 may be assigned one or more predetermined tasks associated with altering the current worksite geography to the desired geography. For example, a single work machine 12 may be assigned the task of removing a particular depth of overburden material from a predefined area, leveling the predefined area to a particular grade, loading a predetermined amount of accumulated material from the predefined area into a waiting haul truck, and other similar predetermined tasks that function to alter the current geography. The predetermined tasks may be manually programmed into controller 16 or, alternatively, determined by controller 16 based on the electronic representations described above and known capabilities of work machine 12.

Controller 16 may automatically determine work machine operations associated with the predetermined task. In particular, controller 16 may reference a list of capabilities unique to the work machine 12 hosting the particular controller 16 (e.g., the host work machine) and stored within a memory of controller 16, and compare these capabilities to the one or more parameters of the desired geography. For example, if the predetermined task assigned to host work machine 12 included removing a predetermined depth of overburden material from a predefined area, controller 16 may compare these task parameters to an engagement depth and/or a removal width capacity of implement system 18, a travel speed or torque capacity of drive system 20, and other similar capacities listed within the memory of controller 16 to generate a schedule of operations that must be completed by the host work machine 12 in a particular order to complete the overall predetermined task. After making the comparison described above, controller 16 may determine the number of passes required of host work machine 12, the positioning and/or orientation of implement system 18, the travel speed and torque output of drive system 20, starting and ending positions of host work machine 12, the travel direction of host work machine 12, and other such operations of host work machine 12 that, when completed in order, will result in the completion of the predetermined task. Controller 16 may then schedule the operations and commence autonomous control of work machine 12 to accomplish the operations according to the schedule. It is contemplated that the operations may alternatively be manually programmed into the memory of controller 16.

The operations stored within the memory of controller 16 may be dynamically updated. In particular, if parameters associated with the current or desired geographies deviate from the original parameters after commencement of the operations described above, controller 16 may revise the schedule of operations. For example, if a soil moisture level increases due to a passing storm, work machine 12 may perform differently than with a lower soil moisture level. Similarly, if a work tool wears or is replaced, the capabilities of work machine 12 may change. Controller 16 may accommodate these deviations by altering the scheduled operations.

During operation of the host work machine 12 it is possible for the host work machine 12 to require assistance from another work machine at work site 10. For example, the host work machine 12 could encounter a large, heavy, or awkward object embedded within overburden material that is unmovable by the host work machine 12. It is also possible for the host work machine 12 to get stuck in loose or viscous material and require a push from or to be dug out by another work machine 12. It is also contemplated that the host work machine 12 could be assigned a task that simply requires two work machines working in tandem such as push-loading a scraper, loading a haul truck, or removing a large berm between two adjacent slots. Without additional capability, completion of the predetermined task by only the host work machine 12 might be impossible.

Controller 16 may remedy this lack of capability by calling on the help of one or more other work machines 12 at the same worksite 10. In particular, in response to encountering the obstacle, getting stuck, or being assigned a task best performed by multiple work machines 12, controller 16 of the host work machine 12 may broadcast via communication device 14 a request for assistance to other work machines 12 at the same worksite 10. This broadcast may be sent to all work machines 12 at worksite 10 or, alternatively, to select work machines 12 based on the particular need for assistance. Included within the request for assistance may be parameters associated with the needed assistance. These parameters could include, for example, the type of obstacle or task (i.e., rock formation, compacted soil, crevice, loose or viscous soil, pushing, loading, etc.), a characteristic of the obstacle or task (i.e., size, shape, hardness, viscosity, quantity, location, etc.), or another suitable parameter. These parameters may be automatically detected by the host work machine 12 or manually programmed into the memory of controller 16. For example, the host work machine 12 may attempt to circumnavigate the embedded object to determine a footprint of the object, may utilize a work tool to determine a height or depth of an obstacle, may monitor an engagement force and corresponding engagement depth of a work tool or traction device to determine a hardness, or may monitor slippage of drive system 20 to determine a viscosity of loose soil. It is contemplated that information obtained through a geological survey of the site may be manually programmed into the memory of controller 16 and accessed by controller 16 for help in determining the assistance parameters, if desired.

Controller 16 may be configured to receive responses to the request for assistance from the other work machines 12 at worksite 10. Specifically, work machines 12 at worksite 10 that are capable of providing the needed assistance may respond to the request for assistance with an indication of available help. Once an indication of available help from the first responding work machine 12 is communicated back to the host work machine, the other work machines at worksite 10 may disregard the original request for assistance and continue with their respective predetermined tasks. If the indication of available help is received within a predetermined period of time, the assistance may be deemed satisfactory and accepted. However, if no assistance is received within the predetermined period of time, controller 16 may rebroadcast the request for assistance along with an urgency parameter indicating that no assistance has yet been received. The predetermined period of time may be variable and correspond to a particular work machine 12, a particular operation or predetermined task, or to a manually designated priority. If no assistance is received after a period of time following the rebroadcast, the urgency parameter may be increased with each new broadcast until assistance is received.

Controller 16 of the host work machine 12 may be configured to receive a similar request for assistance from other work machines 12 at worksite 10. Specifically, the request for assistance may be received via communication device 14 and processed by controller 16. Controller 16 may receive parameters associated with an obstacle preventing completion of a predetermined task by the broadcast work machine 12 (e.g., the one of the other work machines 12 broadcasting the request for assistance) or parameters associated with a predetermined task requiring the efforts of multiple work machines. Controller 16 may then compare the assistance parameters to the list of capabilities associated with and stored within the memory of the host work machine's controller 16. From this comparison, controller 16 may determine if the host work machine 12 is able to provide the requested assistance. It is contemplated that each work machine 12 could alternatively include a list of capabilities associated with the other work machines 12 at work site 10 and perform the comparison for all work machines 12 at worksite 10 before broadcasting a request for assistance. In this situation, the request for assistance may only be broadcast to those work machines 12 capable of providing the needed assistance. Subsequently, the work machine 12 receiving the broadcast may not be required to perform the comparison, because the comparison would already have been performed by the broadcasting work machine 12.

If this comparison performed by controller 16 indicates an ability of the host work machine 12 to assist the broadcast work machine 12 or if the comparison was already performed by the broadcast work machine 12, controller 16 of the host work machine 12 may check the list of operations scheduled for the host work machine 12 and determine an available time slot within the scheduled operations for assisting the broadcast work machine 12. That is, in response to a first request for assistance (e.g., a request without an urgency parameter), controller 16 may interrupt completion of the task predetermined for the host work machine 12 only after completion of a current operation. Once the predetermined task has been completed, controller 16 may communicate to the broadcast work machine 12 the availability to assist and receive in response an acceptance of the offered assistance.

However, as described above, if no work machines 12 at worksite 10 are available to provide the requested assistance within the predetermined period of time, a rebroadcast request for assistance having the urgency parameter may be received by controller 16 of the host work machine 12. Upon receipt of the rebroadcast request for assistance, controller 16 of the host work machine 12 may be configured to respond within a shorter amount of time. As the urgency parameter increases, controller 16 of the host work machine 12 may be configured to respond even quicker, until the response becomes immediate and the current operation is interrupted. After providing the requested assistance, the host work machine 12 may return to the task predetermined for the host work machine 12.

It is contemplated that autonomous control of work machine 12 may be overridden, if desired. In particular, a human operator could monitor the autonomous operations of each work machine 12 at work site 10, as well as the requests for and offers of assistance. At any point in time, it may also be possible for the human operator to override or modify the request for and the offers of assistance. For example, if the ripping assistance of dozer 12d has been requested by another work machine 12 at worksite 10, and damage has previously occurred to the rippers of dozer 12d, dozer 12d could respond with an offer of assistance that dozer 12d is unable to provide. In this situation, a human operator aware of the damage to dozer 12d could override the offer of assistance from dozer 12d. It may also be possible for the human operator to assume full or partial manual control of work machine 12 either directly or remotely.

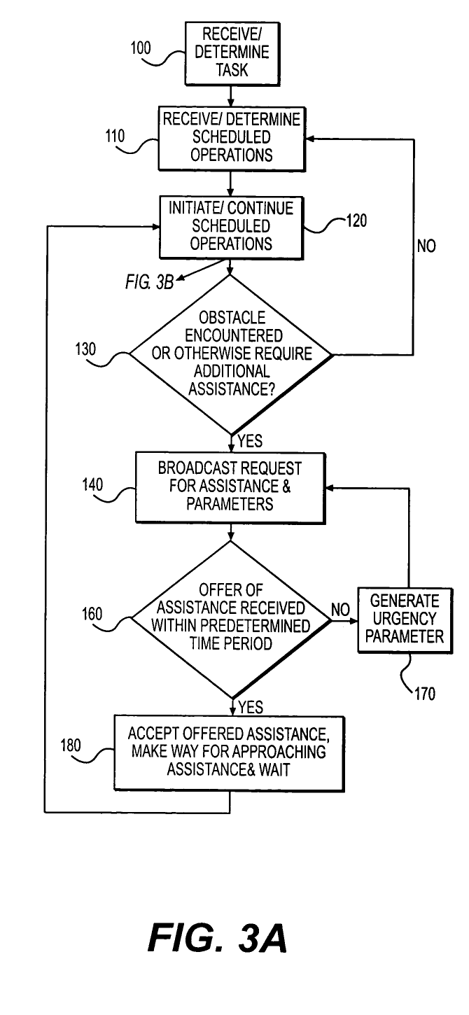

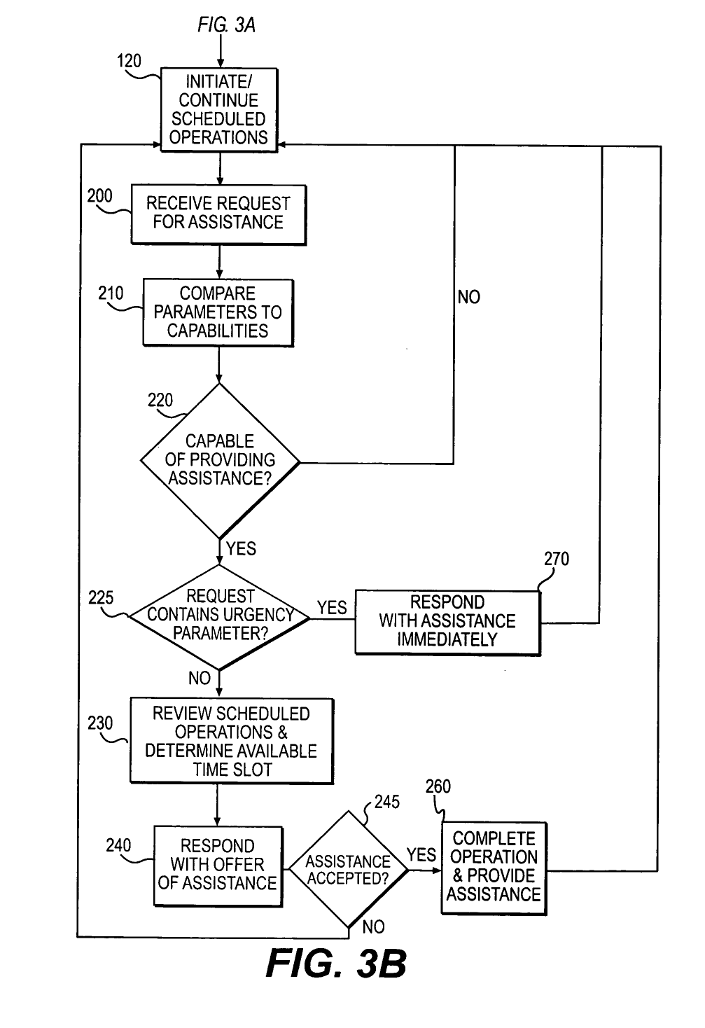

FIGS. 3A and 3B illustrate exemplary methods of controlling work machine 12. FIGS. 3A and 3B will be discussed in the following section to further illustrate the disclosed control system and its operation.

### INDUSTRIAL APPLICABILITY

The disclosed control system may be applicable to work machines operating at a common worksite where cooperative autonomous operation is desired. In particular, the disclosed control system may autonomously request, receive, and provide cooperative assistance in completion of a predetermined task. The autonomous cooperative control of work machine 12 by control system 13 will now be described.

As illustrated in the flowchart of FIG. 3A, the first step in the autonomous control of work machine 12 may include controller 16 receiving or determining a task for the host work machine 12 (e.g., the work machine hosting controller 16) (Step 100). The task may be associated with altering the current geography of worksite 10 to substantially match an architecturally desired geography. The task may be manually programmed into the memory of controller 16 or, alternatively, automatically determined by controller 16. For example, if an elevation difference exists between the current and desired electronic representations and the list of capabilities stored within controller 16 of dozer 12a (referring to FIG. 2) includes the removal of loose surface material, the task for dozer 12a received or determined by controller 16 may include the dozing of overburden material to a specific depth from a predefined area of worksite 10.

Once the task has been received or determined by controller 16, controller 16 may then receive or determine a schedule of operations to be performed in order for the host work machine 12 to complete the predetermined task (Step 110). Continuing with the example of dozer 12a above, controller 16 may either receive or determine a number of dozing passes; a travel speed or direction of dozer 12a; a torque output of drive system 20; a blade engagement depth of implement system 18, position, orientation, or force; a start or stop position; and other associated operations required of dozer 12a to remove the layer of overburden from the predefined area of worksite 10 in an efficient manner. After receiving or determining the schedule of operations, controller 16 may then autonomously control the host work machine 12 to initiate the first operation within the schedule (Step 120).

During operation of the host work machine 12, it is possible for the host work machine 12 to encounter obstacles or be assigned tasks best performed by multiple work machines 12. Upon encountering an obstacle or being assigned such a task, controller 16 may determine if the encountered obstacle is preventing the host work machine 12 from completing the predetermined task or if the assigned task is best performed in tandem with another work machine 12 (Step 130). Controller 16 may determine that the encountered obstacle is preventing the host work machine 12 from completing the predetermined task by monitoring the progress of the host work machine 12 through the schedule of operations. For example, if dozer 12a is midway through a dozing pass and implement system 18 (referring to FIG. 2) engages a rock formation or drive system 20 becomes stuck such that the expected progress of dozer 12a stops or is otherwise hindered, it can be concluded that the obstacle is preventing completion of the predetermined task. If the encountered obstacle is not preventing completion of the predetermined task or if additional assistance is unnecessary, controller 16 may continue directing the host work machine 12 through the scheduled operations (return to Step 120).

However, if additional assistance is required, controller 16 may broadcast via communication device 14 a request for assistance, along with parameters associated with the requested assistance, to all other work machines 12 at worksite 10 (Step 140). Alternatively, controller 16 may compare the parameters to the list of capabilities associated with the other work machines 12 at worksite 10 and broadcast the request for assistance to only those work machines 12 capable of providing the needed assistance. Once the request for assistance has been broadcast, host work machine 12 may wait a predetermined amount of time for a response to the broadcast from the first available work machine 12. Controller 16 may then determine whether or not an acceptable offer of assistance has been received within the predetermined period of time (Step 160). Continuing with the example of dozer 12a above, after requesting help with the encountered rock formation, controller 16 wait to receive a response from dozer 12d (referring to FIG. 2) indicating the ability of dozer 12d to rip apart, reduce, or otherwise remove the rock formation, and an available time slot within the list of operations scheduled for dozer 12d.

If no response to the request for assistance is received within the predetermined period of time, an urgency parameter may be generated (Step 170) and the request for assistance may be rebroadcast, along with the original obstacle or task parameters and the newly-generated urgency parameter (return to Step 140). This process may continue until a satisfactory offer for assistance is received.

However, once an acceptable offer of assistance has been received (e.g., an offer of assistance within the predetermined period of time), controller 16 may accept the offered assistance, control the host work machine 12 to make way for the assisting work machine 12, and wait for completion of the offered assistance (Step 180). Once a response to the host work machine 12 has been received, the other non-responding work machines 12 at worksite 10 may then disregard the request for assistance and continue with their predetermined tasks. After the responding work machine 12 has provided the requested assistance, controller 16 of the host work machine 12 may then continue with the previously prevented operation (return to Step 120). It is contemplated that rather than waiting for completion of the offered assistance, controller 16 of the host work machine 12 may alternatively rearrange operations scheduled for the host work machine 12 such that the host work machine 12 is not idle while the assisting work machine 12 removes or otherwise reduces the encountered obstacle.

The host work machine 12 may also be configured to respond to a request for assistance. As illustrated in the flowchart of FIG. 3B, after autonomously controlling the host work machine 12 to initiate the operations scheduled for the host work machine 12 (Step 120), the first step in responding to a request for assistance may include receiving the request via communication device 14 (Step 200). As indicated above, included within the request for assistance may be parameters associated with an obstacle preventing completion of a task predetermined for the broadcast work machine 12 (e.g., the work machine broadcasting the request for assistance) or other type of assistance needed by the broadcast work machine 12.

After receiving the request for assistance and the corresponding assistance parameters, controller 16 of the host work machine 12 may compare the parameters to the list of capabilities associated with the host work machine 12 and stored within the memory of controller 16 (Step 210). Continuing in reverse roles with the example above, after receiving the request for help from dozer 12a (referring to FIG. 2), dozer 12d may compare the rock formation parameters to the list of capabilities stored within the memory of the dozer's controller 16. This list of capabilities could include, among other things, the ability to penetrate compacted soil a predetermined depth, the ability to dislodge or break-apart rock formations of a particular size, weight, or shape, or other similar capabilities. After comparing the parameters associated with the obstacle encountered by the broadcast work machine 12 to the capabilities of the host work machine 12, controller 16 of the host work machine 12 may determine whether or not the host work machine 12 is capable of providing the requested assistance (Step 220). If the host work machine 12 is incapable of providing the requested assistance, no response from the host work machine 12 may be communicated to the broadcast work machine 12 and the host work machine 12 may continue with its scheduled operations (return to Step 120).

Alternatively, if the broadcast work machine 12 performs the comparison before broadcasting a request for assistance, Steps 210 and 220 may be omitted. In particular, the host work machine 12 may not be required to perform the comparison and determine if the host work machine 12 is capable of providing the assistance, because the comparison would have already been completed by the broadcast work machine 12. In this situation, control may continue from Step 200 immediately to Step 230.

If the host work machine 12 is capable of providing the requested assistance, controller 16 of the host work machine 12 may determine whether or not the broadcasted request for assistance includes an urgency parameter (Step 225). If no urgency parameter is detected, controller 16 of the host work machine 12 may then review the operations scheduled for the host work machine 12 to determine an available time slot within the host work machine's schedule of operations (Step 230). For example, after determining that dozer 12d possesses the capability to remove or otherwise reduce the rock formation encountered by dozer 12a, controller 16 of dozer 12d may review the operations scheduled for dozer 12d. After determining an available time slot within the scheduled operations and after completing those operations scheduled in order before the time slot, a communication may be relayed from the host work machine 12 to the broadcast work machine 12 indicative of the availability to provide the requested assistance (Step 240).

After communicating the ability to provide the requested assistance, controller 16 of the host work machine 12 may then receive from the broadcast work machine 12 a response indicating whether or not the offer of assistance has been accepted (Step 245). If the offer has been accepted, the host work machine 12 may then provide assistance with the encountered obstacle or task (Step 260). However, if the response indicates that the offered assistance is not accepted, the host work machine 12 may disregard the original request for assistance and continue with the predetermined task. After providing the requested assistance, controller 16 of the host work machine 12 may control the host work machine 12 to continue the scheduled operations (return to Step 120).

If the request for assistance received during step 200 does include an urgency parameter, instead of continuing through the flowchart of FIG. 3B to step 230, controller 16 of the host work machine 12 may be configured to respond quicker than the available time slot determined in step 230. Depending on the value of the urgency parameter, the host work machine 12 may even be able to interrupt the current operation and respond immediately with the requested assistance (Step 270).

Because control system 13 provides for cooperative control of multiple work machines operating at a common worksite, tasks having a greater complexity may be autonomously accomplished. In particular, because autonomous completion of a task is no longer limited to the capabilities of a single work machine, the complexity of the task may be increased. The ability to accomplish increasingly complex tasks autonomously may limit the exposure of work machine operators to hazardous or uncomfortable conditions, improve the quality of the completed task, and reduce the cost of completing the task.

It will be apparent to those skilled in the art that various modifications and variations can be made to the disclosed control system. Other embodiments will be apparent to those skilled in the art from consideration of the specification and practice of the disclosed control system. It is intended that the specification and examples be considered as exemplary only, with a true scope being indicated by the following claims and their equivalents.

What is claimed is:

1. A control system for a host work machine operating at a worksite with one or more other work machines, comprising:
a communication device operatively connected to the host work machine; and
a controller having stored in a memory thereof one or more parameters associated with a predetermined task and being configured to:
autonomously control the host work machine to perform the predetermined task; and
upon the host work machine encountering a need for assistance, communicate a request for assistance to at least one of the one or more other work machines via the communication device.

2. The control system of claim 1, wherein the controller is further configured to autonomously control the host work machine to continue performing the predetermined task after receiving the needed assistance.

3. The control system of claim 1, wherein the controller is further configured to communicate one or more parameters associated with the needed assistance to the at least one of the one or more other work machines.

4. The control system of claim 1, wherein:
the controller is further configured to compare one or more parameters associated with the needed assistance to a list of capabilities associated with the one or more other work machines and stored within a memory of the controller; and
the request for assistance is communicated in response to the comparison.

5. The control system of claim 1, wherein the controller is further configured to re-communicate the request for assistance if no response is received within a predetermined period of time following the communication of a request for assistance.

6. The control system of claim 5, wherein the re-communication includes an urgency parameter.

7. The control system of claim 1, wherein the controller is further configured to:
receive a request for assistance from at least one of the one or more other work machines at the worksite;
receive one or more parameters associated with the assistance requested by the at least one of the one or more other work machines;
compare the one or more parameters associated with the assistance requested by the at least one of the one or more other work machines to a list of capabilities associated with the host work machine and stored within a memory of the controller; and
communicate to the at least one of the one or more other work machines an ability to assist the at least one of the one or more other work machines, if the comparison indicates that the host work machine is capable of providing the assistance requested by the at least one of the one or more other work machines.

8. The control system of claim 7, wherein:
the controller includes a scheduled list of operations stored within the memory of the controller, the operations being scheduled for completion by the host work machine in association with the predetermined task; and
the controller is further configured to:
determine an available time slot within the scheduled list of operations; and
provide the requested assistance during the available time slot.

9. The control system of claim 8, wherein the controller is further configured to interrupt completion of the predetermined task to provide the assistance requested by the at least one of the one or more other work machines.

10. The control system of claim 9, wherein the controller is further configured to interrupt completion of the predetermined task only after completion of a current operation.

11. The control system of claim 9, wherein the controller is further configured to interrupt completion of a current operation only after receiving an additional communication from the at least one of the one or more other work machines indicating that no assistance has been received within a predetermined period of time.

12. A control system for a host work machine operating at a worksite, comprising:
a communication device operatively connected to the host work machine; and
a controller having stored in a memory thereof a list of capabilities associated with the host work machine and being configured to:
receive a request for assistance from another work machine at the same worksite;
receive one or more parameters associated with the requested assistance;
compare the one or more parameters to the list of capabilities; and
communicate to the other work machine an ability to assist the other work machine, if the comparison indicates that the host work machine is capable of providing the requested assistance.

13. The control system of claim 12, wherein the controller is further configured to:
determine an available time slot within a list of operations scheduled for completion by the host work machine in association with a predetermined task; and
provide the requested assistance during the available time slot.

14. The control system of claim 13, wherein the controller is further configured to interrupt completion of the predetermined task to provide the requested assistance.

15. The control system of claim 14, wherein the controller is configured to interrupt completion of the predetermined task only after completion of a current operation by the host work machine.

16. The control system of claim 14, wherein the controller is configured to interrupt completion of a current operation by the host work machine only after receiving an additional communication from the other work machine indicating that no assistance has been received within a predetermined period of time.

17. A method of autonomously controlling a first work machine at a worksite, comprising:
receiving one or more parameters associated with a predetermined task;
autonomously controlling the first work machine to perform the predetermined task; and
upon encountering a need for assistance, autonomously communicating a request for assistance to at least a second work machine at the worksite.

18. The method of claim 17, further including autonomously controlling the first work machine to continue performing the predetermined task after receiving the requested assistance.

19. The method of claim 17, further including autonomously communicating one or more parameters associated with the needed assistance to the at least a second work machine.

20. The method of claim 17, further including comparing one or more parameters associated with the needed assistance to a list of capabilities associated with the at least a second work machines and stored within a memory of the controller, wherein the request for assistance is communicated in response to the comparison.

21. The method of claim 17, further including re-communicating the request for assistance if no assistance is received within a predetermined period of time following the communication of a request for assistance.

22. The method of claim 21, wherein the re-communication includes an urgency parameter.

23. The method of claim 17, further including:
autonomously receiving a request for assistance from the at least a second work machine;
autonomously receiving one or more parameters associated with the assistance requested by the at least a second work machine;
autonomously comparing the one or more parameters associated with the assistance requested by the at least a second work machine to a list of capabilities associated with the first work machine; and
autonomously communicating to the at least a second work machine an ability to provide the assistance requested by the at least a second work machine if the comparison indicates that the first work machine is capable of providing the assistance requested by the at least a second work machine.

24. The method of claim 23, further including:
autonomously determining an available time slot within a list of operations scheduled for completion by the first work machine in association with the predetermined task; and
providing the assistance requested by the at least a second work machine during the available time slot.

25. The method of claim 24, further including autonomously interrupting completion of the predetermined task to autonomously provide the assistance requested by the at least a second work machine.

26. The method of claim 25, further including autonomously interrupting completion of the predetermined task only after completion of a current operation by the first work machine.

27. The method of claim 25, further including autonomously interrupting completion of a current operation by the first work machine only after receiving an additional communication from the at least a second work machine indicating that no assistance has been received within a predetermined period of time.

28. A method of autonomously controlling a host work machine operating at a worksite with at least one other work machine, comprising:
autonomously receiving a request for assistance from the at least one other work machine;
autonomously receiving one or more parameters associated with the assistance requested by the at least one other work machine;
autonomously comparing the one or more parameters to a list of capabilities associated with the host work machine; and
autonomously communicating to the at least one other work machine an ability to provide the requested assistance if the comparison indicates that the host work machine is capable of providing the requested assistance.

29. The method of claim 28, further including:
autonomously determining an available time slot within a list of operations scheduled for completion by the host work machine in association with a predetermined task; and
autonomously providing the requested assistance during the available time slot.

30. The method of claim 29, further including autonomously interrupting completion of the predetermined task to provide the requested assistance.

31. The method of claim 30, further including interrupting completion of the predetermined task of the host work machine only after completion of a current operation by the host work machine.

32. The method of claim 30, wherein the controller is configured to interrupt completion of a current operation of the host work machine only after receiving an additional communication from the at least one other work machine indicating no assistance has been received within a predetermined period of time.

33. A host work machine operating at a worksite with one or more other work machines comprising:
an implement system;
a drive system;
a communication system; and
a control system having a controller in communication with the implement, drive, and communication systems, the controller being configured to:
receive one or more parameters associated with a predetermined task;
autonomously control operation of at least one of the implement system and the drive system to perform the predetermined task;
upon the host work machine encountering a need for assistance, communicate via the communication system a request for assistance;
control the host work machine to continue performing the predetermined task after receiving the needed assistance;
receive a request for assistance from the at least one of the one or more other work machines;
receive one or more parameters associated with the assistance requested by the at least one of the one or more other work machines;
compare the one or more parameters associated with the assistance requested by the at least one of the one or more other work machines to a list of capabilities associated with the host work machine; and
communicate to the at least one of the one or more other work machines an ability to provide the assistance requested by the at least one of the one or more other work machines, if the comparison indicates that the host work machine is capable of providing the assistance requested by the at least one of the one or more other work machines.

34. The host work machine of claim 33, wherein:
the controller is further configured to compare one or more parameters associated with the assistance needed by the host work machine to a list of capabilities associated with the at least one of the one or more other work machines and stored within a memory of the controller; and
the request for assistance is communicated in response to the comparison.

35. The host work machine of claim 33, wherein the controller is further configured to re-communicate the request for assistance if no response is received within a predetermine period of time following the communication of a request for assistance.

36. The host work machine of claim 33, wherein the controller is further configured to:
determine an available time slot within a list of operations scheduled for completion by the host work machine in association with the predetermined task; and
communicate the available time slot to the at least one of the one or more other work machines.

37. The host work machine of claim 36, wherein the controller if further configured to interrupt completion of the predetermined task to provide the assistance requested by the at least one of the one or more other work machines.

38. The host work machine of claim 37, wherein the controller is further configured to interrupt completion of the predetermined task only after completion of a current operation by the host work machine.

39. The work machine of claim 37, wherein the controller is further configured to interrupt completion of a current operation by the host work machine only after receiving an additional communication from the at least one of the one or more other work machines indicating that no assistance has been received within a predetermined period of time.
